(19) United States
(12) Patent Application Publication
(10) Pub. No.: US 2008/0284715 A1
(43) Pub. Date: Nov. 20, 2008

(54) DISPLAY DEVICE

(76) Inventor: Yasushi KAWATA, Ageo-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/050,248

(22) Filed: Mar. 18, 2008

(30) Foreign Application Priority Data
May 17, 2007 (JP) 2007-131712

(51) Int. Cl. G02F 1/13357

(52) U.S. Cl. 345/102

(57) ABSTRACT

An angle of incidence of parallel light from a backlight unit that can change the luminance onto a display element is varied by means of an optical element. By increasing the luminance of parallel light from the backlight unit and increasing the angle of incidence of the light onto a liquid crystal display panel by means of the optical element, a wide-angle field is realized. By lowering the luminance of parallel light from the backlight unit and reducing the angle of incidence of the light onto the liquid crystal display panel by means of the optical element, the power consumption in the backlight unit is reduced, and low power consumption is realized. Both of the wide-angle field and the low power consumption are realized.

### INCORPORATION BY REFERENCE

The present application claims priority under 35 U.S.C. §119 to Japanese Patent Application No. 2007-131712 filed on May 17, 2007. The content of the application is incorporated herein by reference in its entirety.

### FIELD OF THE INVENTION

The present invention relates to a display device including a display element which modulates and transmits light from a backlight unit.

### BACKGROUND OF THE INVENTION

A liquid crystal display device for color display called a backlight type has a backlight unit arranged on the rear surface of a liquid crystal display panel that is a liquid crystal display element as a display element including a pair of substrates opposed to each other via a liquid crystal layer.

The liquid crystal display panel has, on its principal surface, a display unit constituted by a number of pixels arranged in a matrix capable of independently controlling their degrees of light transmission in a liquid crystal layer, and light radiated from the backlight unit can be transmitted through this display unit.

One of the advantages of the liquid crystal display device thus constituted is its low power consumption, however, it has been demanded to further reduce the power consumption.

On the other hand, as liquid crystal display devices, recently, there are devices whose images can be clearly observed from a large-angle field with respect to the display unit, that is, which are excellent in terms of wide-angle field.

In this case, observation at a wide view angle on the liquid crystal display device is effective when it is necessary, and for example, this effect is low when a few people observe it without moving.

Based on these circumstances, for example, Japanese Laid-Open Patent Publication No. 5-72529 or Japanese Laid-Open Patent Publication No. 2006-140126 proposes a liquid crystal display device which realizes both of low power consumption and a wide-angle field by making variable the luminance of the backlight unit depending on the scatter characteristics of an optical element disposed between the backlight unit and the liquid crystal panel.

However, in the above-described display device, the luminance and distribution of light to be made incident on the liquid crystal panel from the backlight unit are controlled according to only the scatter characteristics of the optical element, so that distribution of light in an unnecessary direction occurs simultaneously, and it is not easy to realize a design being sufficiently low in power consumption.

The present invention has been made in view of these problems, and an object thereof is to provide a display device which can realize both of a wide-angle field and low power consumption.

### SUMMARY OF THE INVENTION

A display device of the present invention includes a backlight unit which emits parallel light and can change the luminance, a display element which modulates and transmits the light from the backlight unit, and an optical element which is provided between the display element and the backlight unit and changes an angle of incidence of the light from the backlight unit onto the display element. By varying the angle of incidence of parallel light from the backlight unit capable of changing the luminance onto the display element, the luminance of the parallel light from the backlight unit is increased, and by increasing the angle of incidence of the light to the display element by the optical element, a wide-angle field can be realized, and by lowering the luminance of the parallel light from the backlight unit and reducing the angle of incidence of the light onto the display element by the optical element, the power consumption of the backlight unit is reduced and low power consumption can be realized, so that both of the wide-angle field and low power consumption can be realized.

### BRIEF DESCRIPTION OF THE DRAWINGS

FIG. 1 is an explanatory view showing a wide view angle mode of a display device of an embodiment of the present invention;

FIG. 2 is an explanatory view showing a low power consumption mode of the display device;

FIG. 3 is an explanatory view showing an optical element in the wide view angle mode;

FIG. 4 is an explanatory view showing the optical element in the low power consumption mode;

FIG. 5 is a distribution chart showing luminance distribution in the wide view angle mode;

FIG. 6 is a graph showing luminance distribution at a center line from the 0 degree side to the 180 degree side of FIG. 5 in the wide view angle mode;

FIG. 7 is a distribution chart showing luminance distribution in the low power consumption mode; and

FIG. 8 is a graph showing luminance distribution at a center line from the 0 degree side to the 180 degree side of FIG. 7 in the lower power consumption mode.

### DETAILED DESCRIPTION OF THE PREFERRED EMBODIMENT

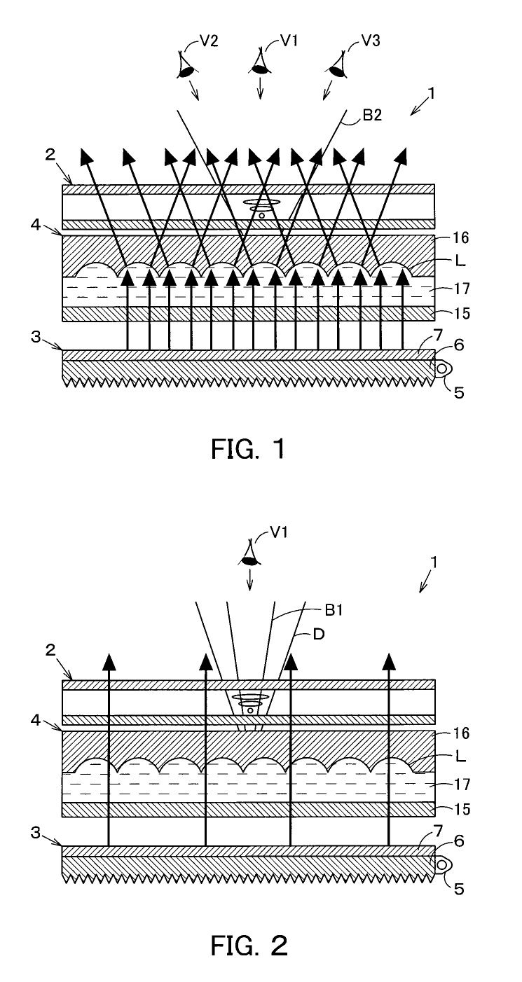

Hereinafter, a constitution of a display device of an embodiment of the present invention will be described with reference to FIG. 1 through FIG. 8.

In FIG. 1 and FIG. 2, the reference numeral 1 denotes a liquid crystal display device as the display device, and this liquid crystal display device 1 includes a so-called active-matrix type liquid crystal display panel 2 that is a liquid crystal display element as the display element, a backlight unit 3 which is a planar light source arranged on the rear surface of the liquid crystal display panel 2, and an optical element 4 arranged between the liquid crystal display panel 2 and the backlight unit 3, wherein the display unit of the liquid crystal display panel 2 is constituted by an aggregation of a plurality of pixels arranged in a matrix not shown so that the respective pixels can independently control modulation of transmitted light which is irradiated from the backlight unit 3 and has an angle of incidence set by the optical element 4.

The liquid crystal display panel 2 is provided with a vertical scanning circuit and a video signal driving circuit not shown as external circuits, and a scanning signal (voltage) is successively supplied to scanning signal lines through this vertical scanning circuit, and in time with this, a video signal (voltage) is supplied from the video signal driving circuit to the video signal lines.

Further, the vertical scanning circuit and the video signal driving circuit are supplied with power from a liquid crystal drive power supply circuit, and image information from the CPU is sorted into display data and a control signal and then inputted therein by a controller.

The backlight unit 3 converts light from an LED chip 5 as a light source into planar light by means of a light guide plate 6 as a light guide and a diffuser 7 and outputs it as parallel light, that is, collimated light, and includes a backlight power supply circuit as backlight unit control means not shown which applies a voltage to the LED chip 5, and via this backlight power supply circuit, the voltage to be applied to the LED chip 5 can be controlled via the backlight power supply circuit. Therefore, the backlight unit 3 is constituted so as to be controlled in luminance by means of the backlight power supply circuit.

The optical element 4 has a function of varying the degree of distribution of light irradiation onto the liquid crystal display panel 2 from the backlight unit 3, and the degree of distribution is controlled by a driving voltage applying circuit 11 as an optical element control means including a pulsed power supply. Specifically, this driving voltage applying circuit 11 controls the voltage to be applied to the optical element 4 so as to control the angle of incidence. By means of the driving voltage applying circuit 11 and the backlight power supply circuit, a controller 13 as a control means is constituted. This controller 13 is constituted so as to linearly control, for example, a corresponding increase and decrease in the luminance of the backlight unit 3 and the increase and decrease in the angle of incidence set by the optical element 4.

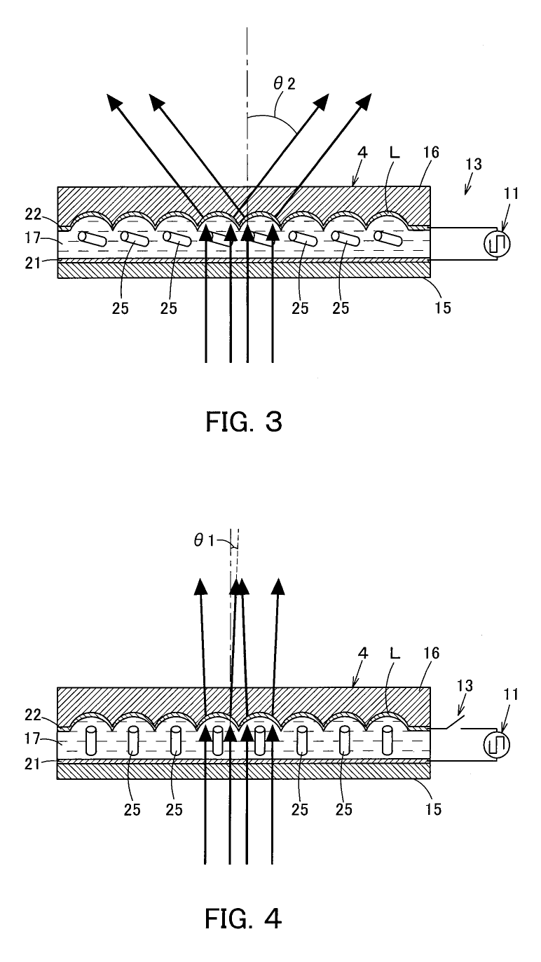

Additionally, as shown in FIG. 3 and FIG. 4, the optical element 4 has transparent substrates 15 and 16 as a pair of substrates with substantially the same size as that of the liquid crystal display panel 2, and between these transparent substrates 15 and 16, a variable refractive index medium 17 as a light modulating layer is provided.

On at least either of opposed surfaces of the transparent substrates 15 and 16, in this embodiment, on the principal surface on the transparent substrate 15 side of the transparent substrate 16, a convex-concave structure for controlling the distribution characteristics is formed in a matrix to form a lens array L. Further, on the principal surfaces on the variable refractive index medium 17 sides of the transparent substrates 15 and 16, transparent electrodes 21 and 22 for electrically controlling light distribution are formed, and the variable refractive index medium 17 is positioned in contact between the transparent substrates 21 and 22.

The transparent substrates 15 and 16 are formed of, for example, glass, resin, or metal oxide, etc., and have a refractive index set to n1. In particular, when it is desired to largely change the angle of distribution, a large difference is necessary between the refractive index of the variable refractive index medium 17 and the refractive index of the transparent substrates 15 and 16, so that, for example, titanium oxide (Ti₂O₃), high-refractive index plastic, or high-refractive index glass is preferably used.

Additionally, for the variable refractive index medium 17, a material whose refractive index largely changes in response to an electric signal is preferably used, and for example, a liquid crystal material, a liquid crystal material and ferroelectric nanoparticles, a ferroelectric thin film, or the like is used. Further, for the variable refractive index medium 17, a solid material which brings about a magneto-optic effect (Kerr effect) can also be used, however, in this case, the applied voltage rises, so that the use is limited. Herein, for example, as the variable refractive index medium 17, a VA-mode liquid crystal layer including a liquid crystal material having negative dielectric anisotropy which turns liquid crystal molecules 25 into a vertically aligned state is used, and the refractive index thereof when no voltage is applied is nS (=n1), and when a predetermined voltage is applied, the difference in refractive index from the transparent substrate 16 having the lens array L formed thereon changes. In other words, the difference between the refractive index in the shorter-axis direction of the liquid crystal molecules 25 and the refractive index of the transparent substrate 16 including the lens array L formed thereon is set to be smaller than the difference between the refractive index in the longer-axis direction of the liquid crystal molecules 25 and the refractive index of the transparent substrate 16 including the lens array L formed thereon, that is, the refractive index in the shorter-axis direction of the liquid crystal molecules 25 is set to be smaller than the refractive index in the longer-axis direction.

As the transparent electrodes 21 and 22, for example, a transparent conductive film of, for example, ITO or IZO can be used, and in terms of the refractive index, a semiconductor thin-film or the like can also be used. These transparent electrodes 21 and 22 are electrically connected to the driving voltage applying circuit 11.

The optical element 4 varies the tilt angle of the liquid crystal molecules 25 of the variable refractive index medium 17 to vary the refractive index thereof by applying a voltage to the transparent electrodes 21 and 22 by the driving voltage applying circuit 11, whereby the refracted state of light made incident on the transparent substrate 16 from the variable refractive index medium 17 can be changed according to the magnitude correlation between the refractive index of the variable refractive index medium 17 and the refractive index of the transparent substrates 15 and 16, and the angle of incidence of the light to be transmitted can be controlled.

In detail, in a state that no voltage is applied between the transparent electrodes 21 and 22, that is, no voltage is applied to the variable refractive index medium 17, the magnitude correlation between the refractive index nS of the variable refractive index medium 17 and the refractive index n1 of the transparent substrates 15 and 16 satisfies nS=n1, so that light to be made incident on the transparent substrate 16 from the variable refractive index medium 17 is not refracted according to Snell's law.

Herein, no refraction occurs on the interface of the transparent substrate 16, so that the lens array L on the principal surface on the side in contact with the variable refractive index medium 17 of the transparent substrate 16 transmits light without almost any change, and a narrow angle of distribution θ1 is maintained.

When a signal voltage is applied between the transparent electrodes 21 and 22, that is, in the state that a voltage is applied to the variable refractive index medium 17, the refractive index of the variable refractive index medium 17 reaches a high value of nL (>nS).

At this time, the magnitude correlation between the refractive index nL of the variable refractive index medium 17 and the refractive index n1 of the transparent substrates 15 and 16 is nL>n1, so that the light to be made incident on the transparent substrate 16 from the variable refractive index medium 17 is refracted according to Snell's law, and the lens array L on the principal surface on the side in contact with the variable refractive index medium 17 of the transparent substrate 16 diffuses the light, so that a wide angle of distribution θ2 is formed.

Further, the optical element 4 is controllable to, for example, 10 degrees≦θ1≦28 degrees and 28 degrees≦θ2≦60 degrees.

Next, operations of the liquid crystal display device of the embodiment will be described.

### (1) Low Power Consumption Mode

In this case, by reducing power supply to the backlight unit 3 from the backlight power supply circuit as shown in FIG. 4 by the controller 13, the illuminance of the backlight unit is weakened, at the same time, the driving voltage from the driving voltage applying circuit 11 to the optical element 4 is set to a predetermined value, for example, zero so that a state with no distribution appears, or the driving voltage is lowered and a state with slight distribution appears.

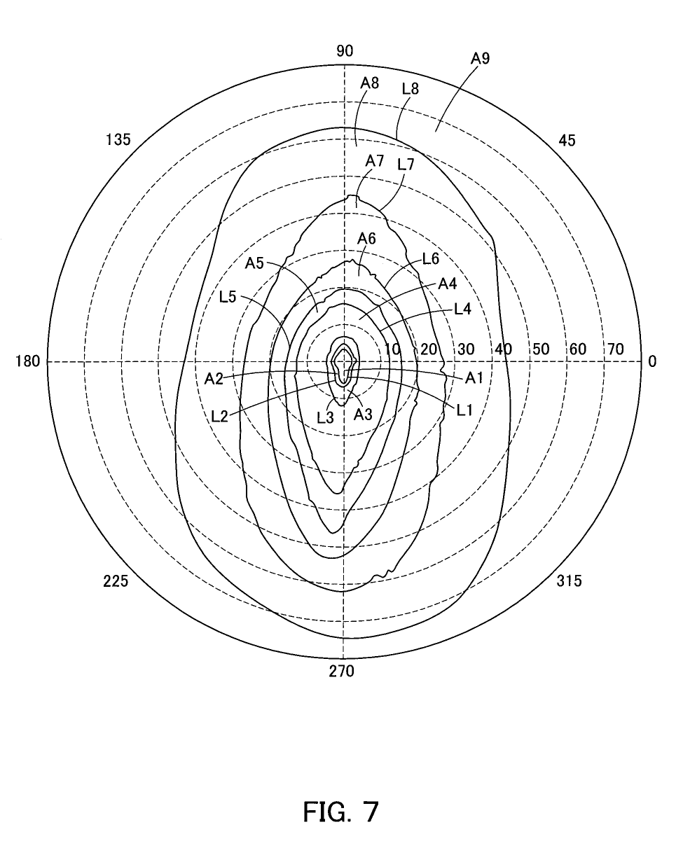

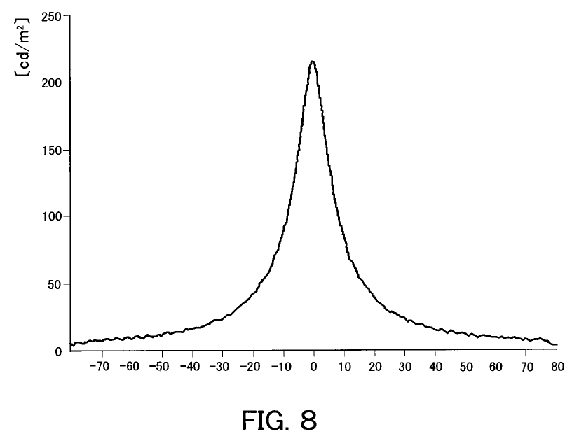

Additionally, in this case, as shown in the distribution chart of FIG. 7 and the graph of FIG. 8, light from the backlight unit 3 is transmitted without almost any change through the optical element 4 and the liquid crystal display panel 2, and as shown in FIG. 2, at a position corresponding to the point of view V1 near the center, a comparatively narrow extremely-bright region B1 is formed, and around this extremely-bright region B1, a dark region D is formed.

In the distribution chart of FIG. 7, the luminances of 360 degrees from the center position are shown, and luminance change positions are shown as contours (isoluminance contours), and it is shown that the luminance lowers from the region A1 partitioned by the contour L1 toward the region A9 positioned outside the contour L8.

For example, when a few observers in front of the liquid crystal display device 1 observe this liquid crystal display device 1 without moving, characteristics for the wide view angle are not especially required in the liquid crystal display device 1, so that use in this mode is sufficient.

### (2) Wide View Angle Mode

In this case, as shown in FIG. 3, by means of the controller 13, the power to be supplied to the backlight unit 3 from the backlight power supply circuit is set to be greater than the power in the low power consumption mode, whereby the luminance is increased, and at the same time, the driving voltage from the driving voltage applying circuit 11 to the optical element 4 is set to a normal voltage higher than the predetermined value in the low power consumption mode, and accordingly, distribution is widened.

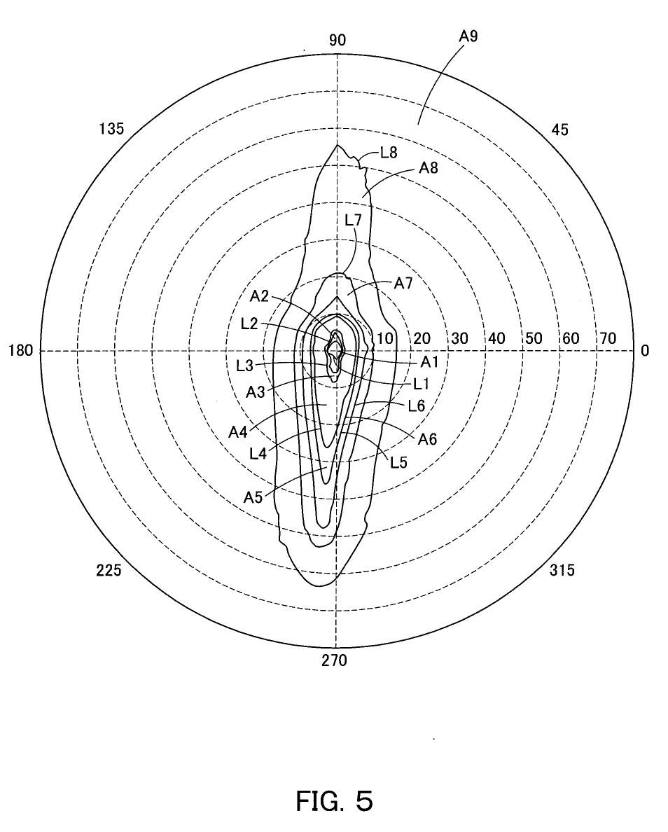

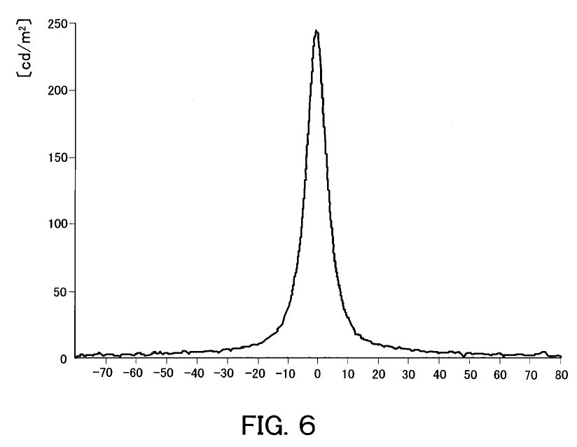

In this case, light from the backlight unit 3 is distributed by the optical element 4, and transmitted through the liquid crystal display panel 2 while being spread as shown in the distribution chart of FIG. 5 and the graph of FIG. 6, and as shown in FIG. 1, a comparatively wide bright region B2 is formed at a position corresponding to the points of view V2 and V3 on the left and right of the point of view V1 near the center.

Additionally, in the distribution chart of FIG. 5, luminances of 360 degrees from the center position are shown, the positions of isoluminances are shown by contours (isoluminance contours), and it is shown that the luminance gets smaller from the region A1 partitioned by the contour L1 toward the region A9 positioned outside the contour L8.

In front of the liquid crystal display device 1, for example, when a few observers observe this liquid crystal display device 1 while moving, or when a large number of observers observe this liquid crystal display device 1 without moving, characteristics for a wide view angle are especially required in the liquid crystal display 1, so that use of this mode as necessary is sufficient.

Thus, according to the above-described embodiment, by varying the angle of incidence of parallel light from the backlight unit 3 which can change the luminance onto the liquid crystal display panel 2 by means of the optical element 4, the luminance of the parallel light from the backlight unit 3 is increased, and by increasing the angle of incidence of the light onto the liquid crystal display panel 2 by means of the optical element 4, the device is adapted to a wide angle field, and by lowering the luminance of the parallel light from the backlight unit 3, the angle of incidence of light onto the liquid crystal display panel 2 by means of the optical element 4, power consumption in the backlight unit 3 is reduced and the device is adapted to low power consumption, so that a wide-angle field and low power consumption are both realized.

By means of the controller 13, by linearly controlling the increase and decrease in the luminance of the backlight unit 3 and the increase and decrease in the angle of incidence set by means of the optical element 4 correspondingly to each other, the wide view angle mode and the low power consumption mode can be easily controlled and switched.

Further, as the variable refractive index medium 17, a VA-mode liquid crystal layer including a liquid crystal material which has negative dielectric anisotropy and has liquid crystal molecules 25 that are set into a vertically aligned state when no voltage is applied is used, whereby light leakage from the backlight unit 3 in the longer-axis direction of the liquid crystal molecules 25 can be prevented even in the low power consumption mode, so that the contrast can be prevented from lowering.

Additionally, in the embodiment described above, the luminance of the backlight unit 3 and the angle of incidence set by means of the optical element 4 may be controlled independently from each other.

Further, as the optical element, an arbitrary element such as an electrowetting element can be used as long as the element can vary the angle of incidence.

Similarly, as the display element, an arbitrary element can be used as long as it modulates and transmits light from the backlight unit 3.

What is claimed is:

1. A display device comprising:
a backlight unit which emits parallel light and can change the luminance thereof;
a display element which modulates and transmits the light from the backlight unit; and
an optical element which is provided between the display element and the backlight unit and changes an angle of incidence of the light from the backlight unit onto the display element.

2. The display device according to claim 1, comprising:
a control means capable of respectively controlling the luminance of the backlight unit and the angle of incidence set by the optical element.

3. The display device according to claim 2, wherein
the control means includes an optical element control means which controls the angle of incidence of light from the backlight unit onto the display element by controlling a voltage to be applied to the optical element.

4. The display device according to claim 2, wherein
the control means can control an increase and decrease in the luminance of the backlight unit and an increase and decrease in the angle of incidence set by the optical element correspondingly to each other.

5. The display device according to claim 4, wherein
the control means can linearly control the increase and decrease in the luminance of the backlight unit and the increase and decrease in the angle of incidence set by the optical element.

6. The display device according to claim 1, wherein
the optical element includes:
a pair of substrates; and
a light modulating layer interposed between these substrates, and
one of the substrates has a lens array on a surface on the light modulating layer side.

7. The display device according to claim 6, wherein
the light modulating layer is a VA-mode liquid crystal layer including liquid crystal molecules which are set into a vertically aligned state when no voltage is applied.
